(19) United States
(12) Patent Application Publication
(10) Pub. No.: US 2015/0205343 A1
(43) Pub. Date: Jul. 23, 2015

(54) TRANSITION TO AN INTERMEDIATE POWER STATE

(71) Applicant: Hewlett-Packard Development Company, L.P., Houston, TX (US)

(72) Inventors: Fred Thomas, III, Ft; Collins, CO (US); Stanley Xu, Cupertino, CA (US); Kenneth Chan, Houston, TX (US)

(21) Appl. No.: 14/414,761

(22) PCT Filed: Sep. 28, 2012
(86) PCT No.: PCT/US2012/058140

§ 371 Date: Jan. 14, 2015

(51) Int. Cl. G06F 1/32

(52) U.S. Cl. CPC G06F 1/3231; G06F 1/3234

(57) ABSTRACT

A computing device includes a non-volatile solid state storage device with a hibernation file. The computing device detects a potential user within proximity of the computing device and transitions the computing device to an intermediate power state from a low power state in response to detecting the potential user.

### BACKGROUND

Consumers appreciate features and enhancements to their computing devices. They also appreciate user “friendliness” and environmentally beneficial (e.g., “green”) computing devices. Businesses may, therefore, endeavor to provide such technology to these consumers.

### BRIEF DESCRIPTION OF THE DRAWINGS

The following detailed description references the drawings, wherein:

FIG. 1 is an example of a computing device.

FIG. 2 is an example of various types of input devices.

FIG. 3 is an example of various types of sensors.

FIG. 4 is an example of instructions stored on a non-volatile storage medium.

FIG. 5 is an example of additional instructions stored on the non-volatile storage medium of FIG. 4.

FIG. 6 is an example of a method for use in a computing device.

FIG. 7 is an example of additional potential elements of the method of FIG. 6.

### DETAILED DESCRIPTION

Computing devices are ubiquitous. They are used in a variety of environments and applications by all sorts of users. They are even present in locations where their unintended activation from a hibernation state and/or use altogether may be obtrusive. For example, the spinning, turning, or “humming” of a hard drive and/or fan of a computing device (to retrieve files, information and/or data stored on it) in a sleeping area may disturb the rest of its occupants and even wake them.

As another example, the full illumination of a computing device screen in the same sleeping area may also disturb the rest of its occupants and even wake them. As a further example, the spinning, turning, or “humming” of a hard drive and/or fan of a computing device, as well as the full illumination of a computing device screen, during the playing or performance of a movie, film, theatrical event or musical event may also be disturbing to others near the computing device.

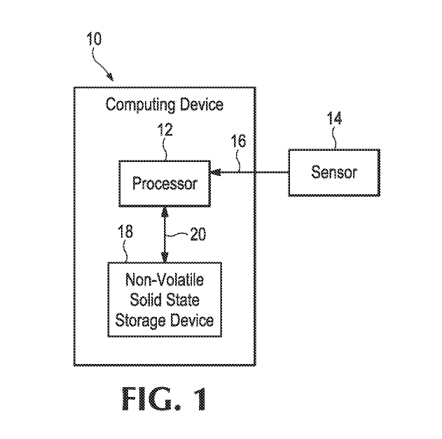

Such unintended activation can also waste energy when a computing device is unintentionally returned from a low power state to a power on state. Another potential concern with such unintentional activation is a shortening of battery life when a computing device is operating on such power sources. This reduction of such battery life and required recharge or replacement can be vexing to some users. An example of a computing device 10 directed to addressing these challenges is illustrated in FIG. 1.

As used herein, the term “processor” is defined as including, but not necessarily being limited to, an instruction execution system such as a computer/processor based system, an Application Specific Integrated Circuit (ASIC), or a hardware and/or software system that can fetch or obtain the logic from a non-transitory storage medium and execute the instructions contained therein. “Processor” can also include any state-machine, microprocessor, cloud-based utility, service or feature, or any other analogue, digital and/or mechanical implementation thereof.

As used herein, the term “non-volatile storage medium” is defined as including, but not necessarily being limited to, any media that can contain, store, or maintain programs, information, and data. A non-transitory storage medium may include any one or a combination of many physical media such as, for example, electronic, magnetic, optical, electromagnetic, or semiconductor media. More specific examples of suitable non-transitory storage medium include, but are not limited to, a magnetic computer diskette such as floppy diskettes or hard drives, magnetic tape, a backed-up random access memory (RAM), a read-only memory (ROM), an erasable programmable read-only memory (EPROM), a flash drive, a compact disc (CD), or a digital video disk (DVD).

As used herein, “computing device” is defined as including, but not necessarily being limited to, a computer, server, phone, tablet, personal digital assistant, peripheral, gaming device, video player, audio player, television, television controller, document repository, storage array, or other similar item. A computing device may be “stand-alone”, independent, dependent, or networked. Additionally, a computing device may run or control one or more services (as a host) to serve the needs of users of other devices on a network. Examples include, but are not limited to, a database server, file server, mail server, print server, web server, gaming server, etc.

As used herein, the term “networked” and “network” are defined as including, but not necessarily being limited to, a collection of hardware (e.g., bridges, switches, routers, firewalls, etc.) and software (e.g., protocols, encryption, etc.) components interconnected by communication channels (intranet, internet, cloud, etc.) that allow sharing of resources and information. The communication channels may be wired (e.g., coax, fiber optic, etc.) and/or wireless (e.g., 802.11, Bluetooth, etc.), use various protocols (e.g., TCP/IP, Ethernet, etc.), have different topologies (ring, bus, mesh, etc.), and be localized (e.g., LAN) or distributed (e.g., WAN).

As used herein, “non-volatile solid state storage device” is defined as including, but not necessarily being limited to, an apparatus that temporarily or permanently stores data for later unobtrusive retrieval. Examples include, but are not limited to, thyristor RAM (T-RAM), zero capacitance RAM (Z-RAM), memristor memory, flash memory, floating gate transistor memory, and/or any additional non-volatile storage medium.

As used herein, “sensor” is defined as including, but not necessarily being limited to, a device that is able to detect the presence of a nearby potential user of a computing device without any physical contact. The sensor can detect for the user in or around a location, area, and/or proximity of the computing device. Examples include, but are not limited to, a camera, an infrared sensor, a motion detector, a Global Positioning System (GPS) sensor, a laser, a photocell, a Doppler effect sensor, etc. The potential user can be any person that may access the computing device.

As uses herein, “hibernate” and “hibernation” are defined as including, but not necessarily being limited to, power states of the Advanced Configuration and Power Interface (ACPI) specification, such as S3, S4, S5 and/or a hybrid thereof where the contents of main memory, such as random access memory (RAM), are placed in one or more hibernate or hibernation files and saved in a non-volatile solid state storage device, and a computing device is then powered down into a low power state. The low power state can include a sleep state, a soft off state, or a mechanical off state of the computing device. The hibernate or hibernation files may include contents of main memory, such as RAM which are stored as an image file in the non-volatile solid state storage device if the computing device is transitioning to the low power state. The contents can include applications, settings, metadata, and/or other files or data loaded into the main memory. The contents of the hibernation files can subsequently be retrieved from the non-volatile solid state storage device and loaded into the main memory, to return or transition the computing device back to a an intermediate power state or a power on state. The intermediate power state is between the low power state and the power on state. Such action can be implemented in any of a variety of different operating systems.

As used herein, “unobtrusive”, “unobtrusively”, “non-obtrusive”, and “non-obtrusively” are defined as including, but not necessarily being limited to, actions, activities, or operations of a computing device, or one or more of its components, that are inaudible, of a low enough sound level so as not to be disturbing, are unnoticeable, and/or do not normally attract attention. For example, the spinning, turning, or “humming” of a hard drive and/or fan of a computing device (to retrieve files, information and/or data stored on it) in a sleeping area may disturb the rest of its occupants and even wake them, whereas retrieving such information from a non-volatile solid state storage device will not create a noise that may disturb them. As another example, the full illumination of a computing device screen in the same sleeping area may also disturb the rest of its occupants and even wake them, whereas a lower, partial illumination may likely not do so.

As used herein, “input device” is defined as including, but not necessarily being limited to, a sensor that detects purposeful user interaction. Examples include, but are not limited to, a keyboard, mouse, stylus, touch pad, gesture sensor, touch sensitive screen, microphone, image capture device, force pad, Near Field Communication Device, button, joy stick, switch, or game controller.

Referring again to FIG. 1, computing device 10 includes a processor 12 and a sensor 14 associated with processor 12, as generally indicated by arrow 16, to receive one or more interrupts therefrom. As can also be seen in FIG. 1, computing device 10 includes a non-volatile solid state storage device 18 coupled to processor 12, as generally indicated by double-headed arrow 20, so that processor 12 can store and retrieve data and files therefrom.

The processor 12 unobtrusively retrieves hibernate files from non-volatile solid state storage device 18 in response to an interrupt received from sensor 14 indicative of a potential user. The processor 12 then transitions the computing device 10 from the low power state to an intermediate power state. In one example, when the computing device 10 transitions to the intermediate power state, one or more unobtrusive components of the computing device 10 are enabled. Further, one or more obtrusive components of the computing device 10 can remain disabled.

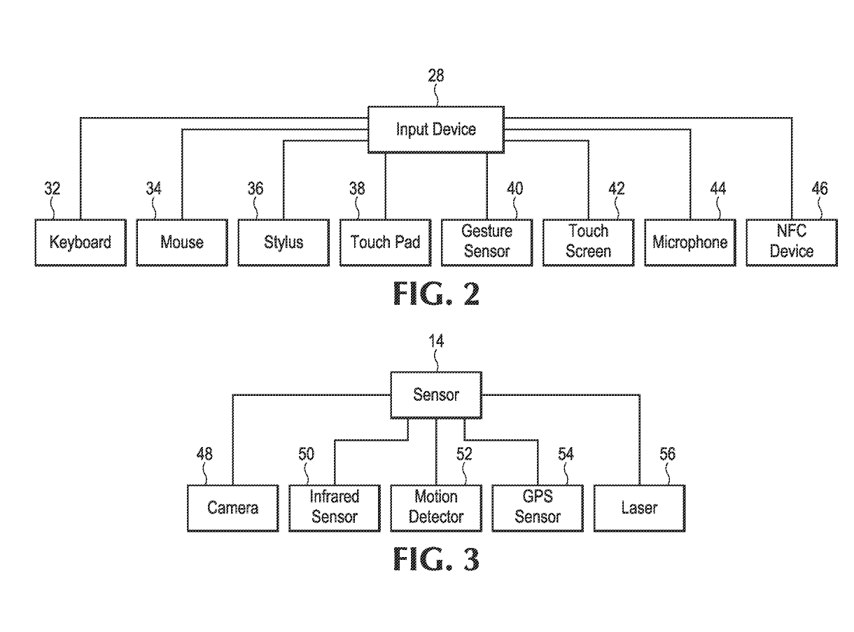

In one implementation, computing device 10 may include an input device 28 (see FIG. 2) associated with processor 12 to generate one or more signals in response to a user accessing input device 28. In response to input device 28 generating such one or more signals, processor 12 transitions computing device 10 from the intermediate power state to a power on state. Processor 12 then retrieves the hibernation file from the non-volatile solid state storage device 18 and loads it into main memory of computing device 10. In another implementation, as the computing device 10 transitions to the power on state, the processor 12 can further enable one or more obtrusive components of the computing device 10.

In some examples of computing device 10, processor 12 can return computing device 10 from the intermediate power state to the low power state a predetermined period of time after the interrupt from the sensor 14 due to inactivation of input device 28 indicated by a lack of a signal therefrom. This feature helps save energy and helps to prevent unintended return of computing device 10 to the fully operational state which may be obtrusive to the user as well as others. This predetermined period of time may be set or configured by the user or processor 12 of computing device 10.

The intermediate power state and/or power on state may be defined or specified by a user of computing device 10. This configurability allows a user of computing device 10 to determine which components and elements of computing device are enabled in these states. Additionally it may allow a user of computing device 10 to control the extent to which these components and elements are enabled. For example, a user may decide not to enable speakers (not shown) of computing device 10 in either or both the intermediate power state or power on state. As another example, a user may decide to only allow a screen (also not shown) of computing device 10 to return to full illumination in the power on state, rather than the intermediate power state. Instead, the user of computing device 10 may decide to only partially illuminate the screen of computing device 10 in the intermediate power state. The configuration for the intermediate power state and/or power on state can be saved as a file. Processor 12 can access the configuration and identify which components are to be enabled or disabled in response to computing device 10 entering the intermediate power state and/or power on state.

An example of various types input devices 28 is illustrated in FIG. 2. As can be seen in FIG. 2, input device 28 may include a keyboard 32, mouse 34, stylus 36, touch pad 38, gesture sensor 40, touch screen 42, a camera (note shown), and/or microphone 44. Some of these input devices 28 may be integrated in computing device 10 (e.g., keyboard 32, mouse 34, touch pad 38, etc.) or separate from computing device 10. Additionally, computing device 10 may include more than one type of input device 28 (e.g., a keyboard 32, mouse 34, and microphone 44). As can additionally be seen in FIG. 2, input device 28 may include a near field communication (NFC) device 46, as defined, for example, in the International Organization for Standards (ISO)/International Electrotechnical Commission (IEC) 18902 and ISO/IEC 21481 specifications. Input device 28 generates one or more signals for processor 12 to detect in response to a user accessing input device 28.

An example of various types of sensors 14 is illustrated in FIG. 3. As can be seen in FIG. 3, sensor 14 may include a camera 48, an infrared sensor 50, a motion detector 52, a Global Positioning System (GPS) sensor 54, and/or laser 56. Some of these sensors 14 may be integrated in computing device 10 (e.g., camera 48, infrared sensor 50, motion detector 52, etc.) or separate from computing device 10. Additionally, a computing device 10 may include more than one type of sensor 14 (e.g., camera 48, GPS sensor 54, and laser 56).

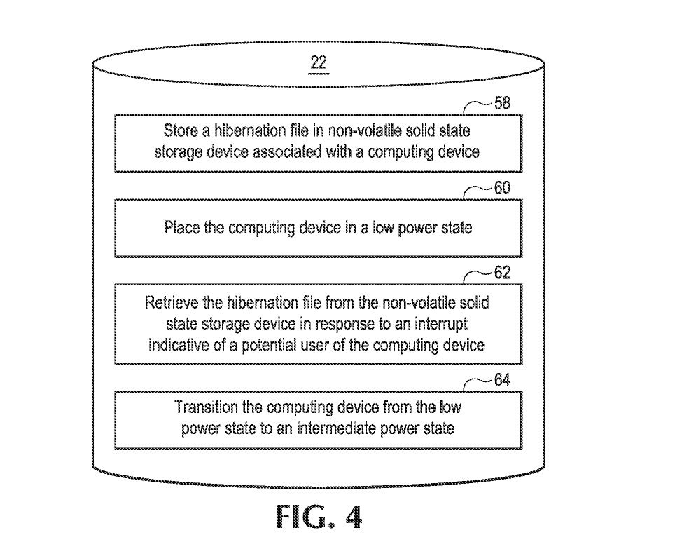

An example of the instructions stored on non-volatile storage medium 22 is illustrated in FIG. 4. As can be seen in FIG. 4, non-volatile storage medium 22 includes instructions that, when executed by processor 12, cause processor 12 to store a hibernation file in non-volatile solid state storage device 18 associated with computing device 10, as indicated by block 58, and place computing device 10 in a low power state, as indicated by block 60. As can also be seen in FIG. 4, non-volatile storage medium 22 includes additional instructions that, when executed by processor 12, cause processor 12 to retrieve the hibernation file from non-volatile solid state storage device 18 in response to an interrupt indicative of a potential user of computing device 10, as indicated by block 62, and transition computing device 10 from the low power state to an intermediate power state, as indicated by block 64. Transitioning the computing device 10 from the low power state to the intermediate power state can include loading contents of the hibernation file back into a main memory, such as RAM, of the computing device 10.

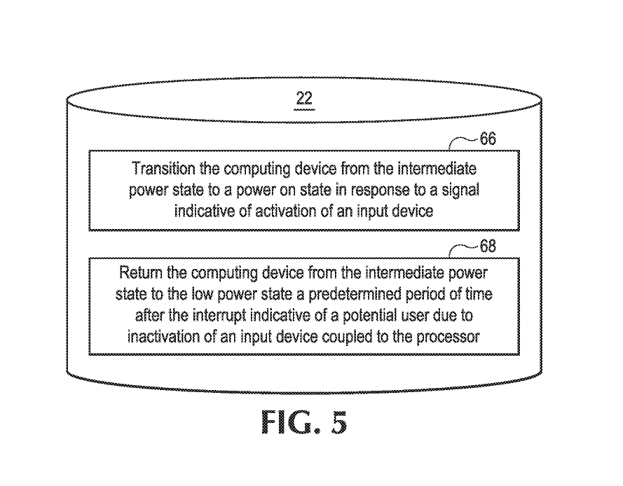

An example of additional instructions that may be stored on non-volatile storage medium 22 is illustrated in FIG. 5. As can be seen in FIG. 5, non-volatile storage medium 22 may include additional instructions that, when executed by processor 12, cause processor 12 to change the condition of computing device 10 from the intermediate power state to a power on state in response to a signal indicative of activation of input device 28, as indicated by block 66. Additionally or alternatively, non-volatile storage medium 22 may include further instructions that, when executed by processor 12, cause processor 12 to return computing device 10 from the intermediate power state to the low power state a predetermined period of time after the interrupt indicative of a potential user due to inactivation of input device 28, as indicated by block 68. In one implementation, the processor 12 stores contents of the main memory back into the non-volatile solid state storage device 18 as the hibernation file when transitioning the computing device 10 back into the low power state.

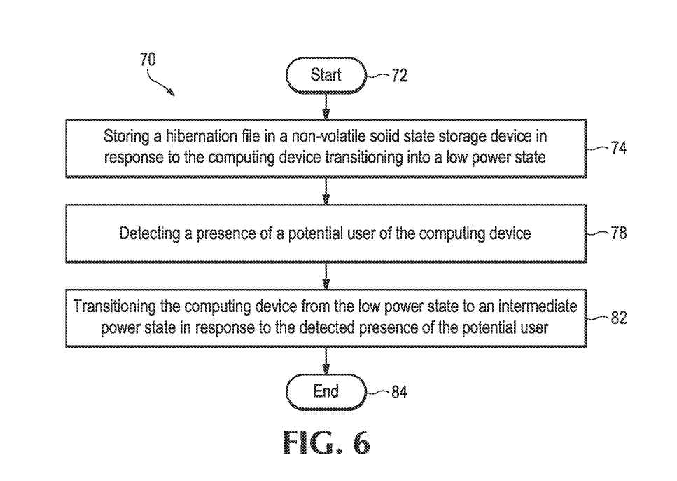

An example of a method 70 for use in computing device 10 is illustrated in FIG. 6. As can be seen in FIG. 6, method 70 starts 72 by storing contents of main memory as a hibernation file in non-volatile solid state storage device 18 in response to computing device 10 transitioning into a low power state, as generally indicated by block 74. Method 70 continues by detecting a presence of a potential user of computing device 10, as generally indicated by block 78. Method 70 additionally continues by transitioning computing device 10 from the low power state to an intermediate power state in response to the detected presence of the potential user, as generally indicated by block 82. Method 70 may then end 84.

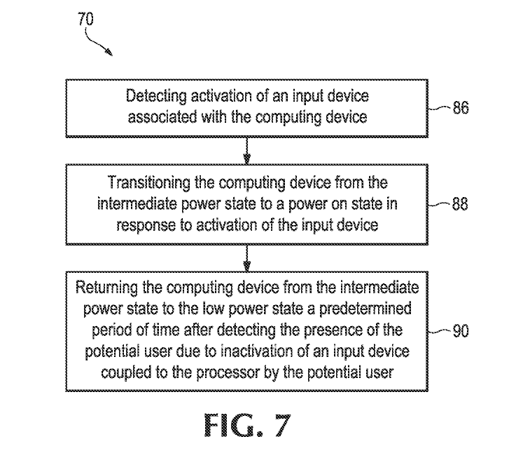

An example of additional potential elements for method 70 is illustrated in FIG. 7. As can be seen in FIG. 7, method 70 may also include detecting activation of input device 28 associated with computing device 10, as generally indicated by block 86, and transitioning computing device 10 from the intermediate power state to a power on state in response to activation of input device 28, as generally indicated by block 88. Method 70 may additionally or alternatively further include returning computing device 10 from the intermediate power state to the low power state a predetermined period of time after detecting the presence of the potential user due to inactivation of input device 28 by the potential user, as generally indicated by block 90.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. The spirit and scope of the present invention are to be limited only by the terms of the following claims.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. A computing device, comprising:
a non-volatile solid state storage device to include a hibernation file;
a sensor to detect for a potential user within proximity of the computing device; and
a processor to transition the computing device from a low power state to an intermediate power state with the hibernation file in response to receiving an interrupt from the sensor indicative of a potential user.

2. The computing device of claim 1, further comprising:
an input device associated with the processor; and
wherein the processor transitions the computing device from the intermediate power state to a power on state in response to a signal received from the input device.

3. The computing device of claim 2, wherein the input device includes one of a keyboard, mouse, stylus, touch pad, gesture sensor, touch screen, microphone, and near field communication device.

4. The computing device of claim 1, wherein the processor transitions the computing device from the intermediate power state to the low power state a predetermined period of time after the interrupt from the sensor due to inactivation of an input device coupled to the processor.

5. The computing device of claim 1, wherein the sensor includes one of a camera, an infrared sensor, a motion detector, a Global Positioning System (GPS) sensor, and a laser.

6. The computing device of claim 1, wherein a feature of one of the intermediate power state and a power on state are defined by a user.

7. A non-volatile storage medium including instructions that, when executed by a processor, cause the processor to:
store a hibernation file in a non-volatile solid state storage device associated with a computing device;
place the computing device in a low power state;
retrieve the hibernation file from the non-volatile solid state storage device in response to an interrupt indicative of a potential user of the computing device; and
transition the computing device from the low power state to an intermediate power state.

8. The non-volatile storage medium of claim 7, further comprising instructions that, when executed by the processor, cause the processor to transition the computing device from the intermediate power state to a power on state in response to a signal indicative of activation of an input device.

9. The non-volatile storage medium of claim 7, further comprising instructions that, when executed by the processor, cause the processor to return the computing device from the intermediate power state to the low power state a predetermined period of time after the interrupt indicative of a potential user due to inactivation of an input device coupled to the processor.

10. The non-volatile storage medium of claim 7, in a computing device that includes the processor.

11. The non-volatile storage medium of claim 7, wherein a feature of one of the intermediate power state and a power on state are defined by a user.

12. A method for use in a computing device, comprising:
storing a hibernation file in a non-volatile solid state storage device in response to the computing device transitioning into a low power state;
detecting a presence of a potential user of the computing device; and
transitioning the computing device from the low power state to an intermediate power state in response to the detected presence of the potential user.

13. The method of claim 12, further comprising:
detecting activation of an input device associated with the computing device; and
transitioning the computing device from the intermediate power state to a power on state in response to activation of the input device.

14. The method of claim 12, further comprising returning the computing device from the intermediate power state to the low power state a predetermined period of time after detecting the presence of the potential user due to inactivation of an input device coupled to the processor by the potential user.

15. The method of claim 12, wherein a feature of one of the intermediate power state and the power on state are defined by a user.
